(19) United States
(12) Patent Application Publication
(10) Pub. No.: US 2016/0335155 A1
(43) Pub. Date: Nov. 17, 2016

(54) Method and Device for Storing Data, Method and Device for Decoding Stored Data, and Computer Program Corresponding Thereto

(71) Applicant: ENVOR TECHNOLOGIE, Cergy Pontoise (FR)

(72) Inventor: Alan Jule, La Garenne-Colombes (FR)

(21) Appl. No.: 15/111,710

(22) PCT Filed: Jan. 13, 2015
(86) PCT No.: PCT/EP2015/050518

§ 371 Date: Jul. 14, 2016

(30) Foreign Application Priority Data
Jan. 14, 2014 (FR) 1450267

(51) Int. Cl. G06F 11/10; G06F 3/06

(52) U.S. Cl. CPC G06F 11/1016; G06F 3/065; G06F 3/0619; G06F 3/0685

(57) ABSTRACT

A method is provided for storing data. The method implements an error-correction code defining a set of variables linked by constraints, each variable being associated with source data and/or redundancy data. The method implements the following steps: determining variables forming at least one stopping set of said code, determining a scheme for allocating said variables, allocating a distinct storage carrier to each variable forming a stopping set, distributing said variables, or data associated with said variables, to said storage carriers according to said allocation scheme.

### 1. FIELD OF THE INVENTION

The field of the invention is that of the storage of data.

More specifically, the invention relates to a technique for storing data relying on the use of an error-correction code, and more specifically on the use of a graph code in order to ingeniously distribute the data amongst the different storage carriers.

In particular, the invention relies on the use of sparse graph codes.

The invention finds application especially in the storage of personal data, company data, etc.

### 2. PRIOR ART

We shall strive here below to describe a set of problems and issues existing in the field of centralized networks with distributed storage (CNDS). Naturally, the invention is not restricted to this particular field of application but is of interest for any technique of storage that has to cope with a proximate or similar set of problems and issues.

A CNDS network is classically constituted by a master server, one or more sets of hard disk drives each of which has a slave server, and clients. The master server is responsible for receiving files from clients, distributing them and transmitting them to slave servers. A slave server is responsible for encoding the files and distributing the bytes generated amongst the hard disk drives at its disposal. In the event of failure of a hard disk drive, the slave server that is associated with it is responsible for recovering the erased data from previously computed parity values. During the reading of the data stored by a client, the master server transmits the request to the concerned slave servers, collects data and transmits it to the client.

FIG. 1 illustrates an example of a CNDS network comprising four clients 11 to 14, a set of five hard disk drives D1 to D5 and a unique server 15 responsible for master and slave tasks.

To protect the stored data from failure or from the loss of a hard disk drive in particular, replication (making multiple copies of files on different hard disk drives) must be used or else the data must be encoded by means of an error-correction code. An error-correction code is a code enabling a decoder to detect or correct deterioration following transmission or storage. Such an error-correction code introduces redundancy, enabling erased data to be rebuilt in the event of failure of a hard disk drive.

Returning to the example illustrated in FIG. 1, a first set of source data (D1A) of a first code word is, for example, stored on the disk drive D1, a second set of source data (D2A) of the first code word is stored on the disk drive D2, a third set of source data (D3A) of the first code word is stored on the disk drive D3, a fourth set of source data (D4A) of the first code word is stored on the disk drive D4, and a set of redundancy data (PA) of the first code word is stored on the disk drive D5. In the same way, for example a first set of source data (D1B) of a second code word is stored on the disk drive D1, a second set of source data (D2B) of the second code word is stored on the disk drive D2, a third set of source data (D2C) of the second code word is stored on the disk drive D3, a set of redundancy data (PB) of the second code word is stored on the disk drive D5 and a fourth set of source data (D2D) of the second code word is stored on the disk drive D4, etc.

According to another example, if we consider a network comprising N hard disk drives, such that N-M hard disk drives store source data (also called user data) and M hard disk drives store redundancy data (also called parity data) and if the error-correction code is an MDS code, then the system can withstand M simultaneous failures without losing any data.

The main algorithms currently being used for data storage on CNDS networks, which combine protocols for allocating data on the storage network as well as computations of redundancy if necessary (encoding), are defined by the term RAID (Redundant Array of Independent Disk drives). In information technology, the word RAID designates techniques used to distribute data amongst several hard disk drives in order to heighten malfunction tolerance or security or overall performance or a combination of all these factors.

The RAID protocol was originally proposed to form a high-capacity, hence costly, hard disk drive based on several small, inexpensive but less reliable hard disk drives.

The hard disk drives connected in a network can use different RAID algorithms known as RAID levels. Each of these levels constitutes a mode of use of the network of hard disk drives, depending on the following factors:
performance: measurement of rebuild times and of the number of simultaneous failures supported,
cost of storage: ratio between the number of bytes available for storage and total number of bytes in the network,
access to hard disk drives: measurement of write and read times when there are no failures on the network.

The constitution of the different RAID networks therefore results from a compromise among the different parameters that are: protection against hard disk drive failure, speed of reading/writing/rebuilding of data on the network, and finally storage costs. The main limitation of this technology is that there is no RAID level that can be used to manage several simultaneous failures of hard disk drives at low storage cost and with low complexity.

The main technological obstacle comes from the error-correction code which is used to protect the stored data.

Indeed, for data storage networks, the code classically used is an MSD (maximum separable distance) type code (or combinations of MSD codes). Such a code is deterministic. Thus, for each of the RAID levels, the code used is an MSD code.

However, such an MSD type error-correction code is complex and difficult to use when coping with more than two failures, because it is slower than solutions without error-correction codes. In addition, the use of such an MSD type error-correction code generates far higher costs owing to the high-performance equipment needed to carry out computations.

### 3. SUMMARY OF THE INVENTION

The invention proposes a novel solution that does not have all these drawbacks of the prior art in the form of a method for storing data, the method implementing an error-correction code defining a set of variables linked by constraints, each variable being associated with source data and/or redundancy data.

According to the invention, such a method implements the following steps:
determining variables forming at least one stopping set of the code,
determining a scheme for allocating the variables, allocating a distinct storage carrier to each variable forming a stopping set,
distributing variables, or data associated with the variables, to the storage carriers according to the allocation scheme.

By distributing the variables forming a stopping set (or values/data carried by these variables) among different storage carriers, it is possible to use an iterative decoder to recover the source data even in the event of loss or failure of at least one of the storage carriers. Thus, the decoding complexity is reduced.

More specifically, determining the variables that form a stopping set makes it possible to identify the variables that must not be erased simultaneously to enable recovery of the source data. The distribution of the variables that form a stopping set amongst distinct storage carriers therefore prevents the blocking of the decoder that could occur if all the variables forming a stopping set were to be erased simultaneously in the event of failure of a storage carrier.

The notion of a stopping set is well known to those skilled in the art and is recalled especially in Richardson and Urbanke, “Modern Coding Theory”. By definition, such a stopping set is a sub-set of the set of variables such that all the constraint nodes (also called parity nodes) that are connected to the variables forming the stopping set, in the representation in the form of a Tanner graph, are connected at least twice to the variables forming the stopping set. The size of a set (cycle) is defined by the number of constraint nodes and variables thus connected.

It may also be recalled that those skilled in the art know ways of representing an error-correction code equivalently in the form of a Tanner graph, a system of parity equations or a matrix equation with generator matrix or parity check matrix. In particular, the representations in the form of a Tanner graph or a system of parity equations are generic since they propose a set of combinations which the variables (source data and/or redundancy data) must comply with. The representations in the form of a matrix equation with generator matrix can be used to determine the redundancy data from source data chosen from among the variables.

In particular, it can be noted that the source data or redundancy data can be bits or symbols, and correspond to values carried by the variables.

Thus, the method for storing data according to the invention can implement a step for encoding at least one vector comprising source data, delivering at least one vector to be stored comprising source data and/or redundancy data in applying the error-correction code to the source data. The step for distributing can then allocate the values of associated variables to the vector or vectors to be stored in the plurality of storage carriers.

In particular, an error-correction code according to the invention is designed to correct the erasure type errors of (within) a storage carrier.

According to one particular characteristic of the invention, the error-correction code is a sparse graph type code, of which the generator matrix or parity check matrix is a sparse matrix.

In other words, such a code can be represented by a generator matrix or a parity check matrix comprising chiefly zeros. This is for example an LDPC (low density parity check) type code or a code derived from an LDPC code.

Such graph codes have low complexity and therefore make data encoding and decoding less complex than with the MSD encoding techniques classically used in data storage.

It can also be noted that the use of graph codes to store data is not an obvious step because these codes conventionally have a probabilistic character and are therefore used rather when a retransmission of data is possible. This is why the prior art on data storage relates chiefly to MSD codes.

According to another specific characteristic of the invention, the method implements a preliminary step for building the error-correction code which determines a generator matrix or a parity check matrix formed from a repetition of at least one predetermined scheme, called a structured matrix.

Such a cyclic or quasi-cyclic structure of the matrix makes it possible to swiftly determine the short cycles, and especially the stopping sets of the error-correction code.

In particular, the shape and/or the size of the generator matrix or the parity check matrix can be defined in taking account of the number of storage carriers available and/or the number of erasures of variables/failures of storage carriers authorized.

Thus, the number of columns of the generator matrix or the parity check matrix must be equal to the number of storage carriers or to a multiple of the number of storage carriers.

According to one particular characteristic of the invention, the error-correction code is a systematic code.

Because of this, the vector to be stored, obtained as a result of the encoding, carries both source data and redundancy data. Thus, a part of the data stored (the part corresponding to the source data) can be read without performing any mathematical operations.

To this end, the code is built with a generator matrix carrying an identity matrix.

According to a first alternative embodiment, the step for distributing stores source data and/or redundancy data associated with/allocated to a given variable on a same storage carrier.

In this way, the source data or redundancy data of each vector to be stored are distributed identically amongst the different storage carriers, thus optimizing the decoding time.

According to a second alternative embodiment, the step of distribution stores the source data and/or redundancy data associated with/allocated to a same variable on distinct storage carriers.

In this way, the step for distributing variables is carried out “stripe by stripe” in determining a first scheme of allocation for a first stripe corresponding to a first vector to be stored and then a second scheme of allocation for a second stripe corresponding to a second vector to be stored, a third scheme of allocation for a third stripe corresponding to a third vector to be stored, etc. Advantageously, the invention uses the same allocation scheme for the different stripes but in working on distinct storage carriers: for example, the variables v0, v1, v2 are stored on a first storage carrier for the first stripe, on a second storage carrier for the second stripe and on a third storage carrier for the third stripe.

In particular, the storage carriers belong the group comprising:
hard disk drives,
magnetic tapes,
flash memories,
etc.

In particular, such storage carriers can be networked.

Such a network can by dynamic and flexible. In the event of modification of the network, the steps for building an error-correction code and for allocating (determining stopping sets, determining an allocation scheme, distributing variables on the different storage carriers) can be implemented again. Should the number of storage carriers available be diminished, it is also possible to adapt the allocation by eliminating certain columns from the allocation matrix without redoing the steps of code-building, determining stopping sets and determining an allocation scheme.

According to one particular characteristic, all the storage carriers have the same size.

In another embodiment, the invention pertains to a device for storing data using an error-correction code defining a set of variables linked by constraints, each variable being associated with source data and/or redundancy data.

According to the invention, such a device comprises:
a module for determining variables forming at least one stopping set of the code,
a module for determining a scheme for allocating variables, allocating a distinct storage carrier to each variable forming a stopping set,
a module for distributing variables or data associated with the variables on the storage carriers according to the allocation scheme.

Such a data storage device is especially suited to implementing the method for storing data described here above. It is for example integrated into a server (slave or master-slave) of a CNDS network, responsible for encoding the user data and for distributing the generated encoded data on the storage carriers at its disposal.

Such a data storage device could of course comprise the different characteristics of the method for storing data according to the invention, which can be combined or taken in isolation. Thus, the characteristics and advantages of this data storage device are the same as those of the method for storing data. They are therefore not described in more ample detail.

The invention also relates to a method for decoding data stored in a plurality of storage carriers, the data having been preliminarily stored in a plurality of storage carriers by the implementing of an error-correction code defining a set of variables connected by constraints, each variable being associated with source data and/or redundancy data, and the determining of variables forming at least one stopping set of the code, the determining of a scheme of allocation of the variables, allocating a distinct storage carrier to each variable forming a stopping set, and the distributing of variables or data associated with the variables amongst the storage carriers, according to an allocation scheme, such as defined here above.

According to the invention, such a method of decoding implements a step for decoding comprising at least one iteration of the following steps when at least one of the storage carriers has failed:
searching, in a system of equations representing the code, for at least one equation presenting a single variable associated with data preliminarily stored in the failed storage carrier or carriers, called an erased variable,
rebuilding the data associated with the erased variable or variables by resolving said equation or equations, delivering at least one rebuilt data,
updating the system of equations taking account of the at least one rebuilt data.

The invention thus enables the implementing of an iterative type decoding for application in the field of data storage. Such a decoding can offer lower complexity than the decoding techniques conventionally used in this field.

In particular, such a method of decoding is suited to decoding data stored according to the storage method described here above. Thus, the characteristics and advantages of this method for decoding stored data are the same as those of the method for storing data.

In particular, if the step of distribution stores the source data or redundancy data associated with/allocated to a given variable on a same storage carrier, the decoding method memorizes the order of resolving of the equations of the system of equations implemented during the step for decoding a first set of stored data. During the step for decoding at least one second set of stored data, the method for decoding resolves the equations of the system of equations according to this order of resolution.

Thus, a remarkable gain in time is obtained in the decoding of the data.

In another embodiment, the invention relates to a device for decoding data stored in a plurality of storage carriers, the data having been preliminarily stored in the plurality of storage carriers by means of a device for storing data using an error-correction code, defining a set of variables connected by constraints, each variable being associated with source data and/or redundancy data, and comprising a module for determining variables forming at least one stopping set of the code, a module for determining a scheme for allocating variables, allocating a distinct storage carrier to each variable forming a stopping set and a module for distributing variables or data associated with the variables on the storage carriers, according to a scheme of allocation as defined here above.

According to the invention, such a decoding device comprises a decoding module comprising:
a search module for making a search, in a system of equations representing the code, for at least one equation having a single variable associated with data preliminarily stored on the failed storage carrier or carriers, called an erased variable,
a module for rebuilding the data associated with the erased variable or variables, by resolution of the equation or equations, delivering at least one rebuilt data,
a module for updating the system of equations taking account of the at least one rebuilt data,
   the search, rebuilding and updating modules being activated at least once, in the form of at least one iteration, when at least one of the storage carriers has failed.

Such a device for decoding stored data is especially suited to implementing the method for decoding stored data described here above. It is for example integrated into a server (slave or master-slave server) of an CNDS network responsible for reading the stored data and rebuilding the erased data.

Such a device for decoding stored data could of course include the different characteristics of the method for decoding stored data according to the invention, which can be combined or taken in isolation. Thus, the characteristics and advantages of this device for decoding stored data are the same as those of the method for decoding stored data. They shall therefore not be described in more ample detail.

The invention also relates to one or more computer programs, comprising instructions for the execution of the steps of the method for storing data as described here above and/or the method for decoding stored data as described here above when the program or programs are executed by a computer.

The methods according to the invention can be implemented in various ways, especially in wired form or in software form.

### 4. LIST OF FIGURES

Other features and characteristics of the invention shall appear more clearly from the following description of a particular embodiment and of the appended drawings, of which:

FIG. 1 illustrates an example of a CNDS network;

FIG. 2 is a reminder of the notion of a Tanner graph;

FIG. 3 presents the main steps implemented by a method for storing data according to at least one embodiment of the invention;

FIGS. 4A and 4B illustrate the general principle of the distribution of the variables forming a stopping set on distinct storage carriers;

FIGS. 5A and 5B illustrate an example of distribution of the variables forming stopping sets on ten hard disk drives;

FIG. 6 presents the distribution of the data of a vector to be stored on ten hard disk drives obtained at the end of the storage operation;

FIGS. 7 and 8 illustrate the distributions of the data of three vectors to be stored on ten hard disk drives obtained at the end of the storage operation, according to two variants;

FIG. 9 presents another example of an allocation matrix on eight hard disk drives;

FIG. 10 presents the main steps implemented by a method for decoding stored data according to at least one embodiment of the invention;

FIGS. 11 and 12 respectively illustrate the simplified structure of a storage device implementing a technique of data storage and the simplified structure of a device for decoding data stored according to one particular embodiment of the invention.

### 5. DESCRIPTION OF ONE EMBODIMENT OF THE INVENTION

### 5.1 General Principle

The general principle of the invention relies on the use of error-correction codes of a particular type, namely graph codes, especially “sparse” type graph codes, for data storage applications. The proposed solution relies on an algorithm associating a specific error-correction code and an allocation of data in order to obtain a deterministic behavior of the graph codes. This enables the use of codes of low complexity for data storage systems.

It can be noted that this approach is not obvious to those skilled in the art for whom graph codes can be used for an application in which a retransmission of data is possible owing to the probabilistic character of the codes and not for a data storage application. The particular structure of the code used according to the invention, combined with an ingenious distribution of the variables associated with this code, make it possible to obtain a deterministic behavior of the graph codes. It is thus possible, according to the invention, to use graph codes having low complexity of encoding and decoding (iterative) for data storage.

In particular, the data storage model proposed can be simulated by a block erasure channel (BLEC) with a variable code word size.

The expression “d_max” denotes maximum network protection, i.e. the maximum number of erased storage carriers that the network can take. The erasure model is then:
loss of a storage carrier with a probability P1;
loss of two storage carriers with a probability P2<P1;
. . .
loss of d_max storage carriers with a probability Pd_max< . . . <P2<P1;
loss of d_max+1 storage carriers with a probability Pd_max+1=0.

If all the storage carriers are considered to be independent, we have: P2=(P1)² . . . , Pd_max=(P1)^{d}^{_}^{max}. The model is then simplified and corresponds to the BEC (binary erasure channel).

The proposed data storage model corresponds to a particular BLEC channel with P1>P2> . . . >Pd_max. This means that the probability of erasure of a data carrier is considered to be dependent on the state of the rest of the network (i.e. of all the storage carriers).

In addition, Pd_max+Δ=0 with Δ as an integer such that Δ>0. This means that the data stored on more than d_max storage carriers cannot be erased simultaneously.

It is also noted that, for the data storage, no retransmission is possible. It is therefore necessary to ensure protection against all failures sized d_max. In addition, the rebuilding must be ensured in minimizing storage costs i.e. the number of redundancy symbols must tend towards d_max.

By distributing the variables forming a stopping set (or the values/data carried by these variables) amongst different storage carriers, it is thus possible to use an iterative decoder to recover the source data, even in the event of loss or failure of d_max storage carriers. Thus, the decoding is ensured. At the same time, the benefit of low complexity of iterative decoding is obtained.

### 5.2 Reminder on Graph Codes

“Sparse” graph codes combine various families of error-correction codes. The first class of these codes, called LDPC, was introduced by Robert Gallager. The name of these codes comes from the fact that, unlike in the MDS codes for example, the generator matrix (or parity check matrix) used comprises many zeros, making the computation of the parity bits less complex since it requires fewer operations. The term “graph code” comes from the representation in graph form, generally bipartite form, which Tanner has proposed for these codes. This representation has been extended to classes derived from LDPC codes, and the term graph code today covers these numerous code with low encoding and/or decoding complexity.

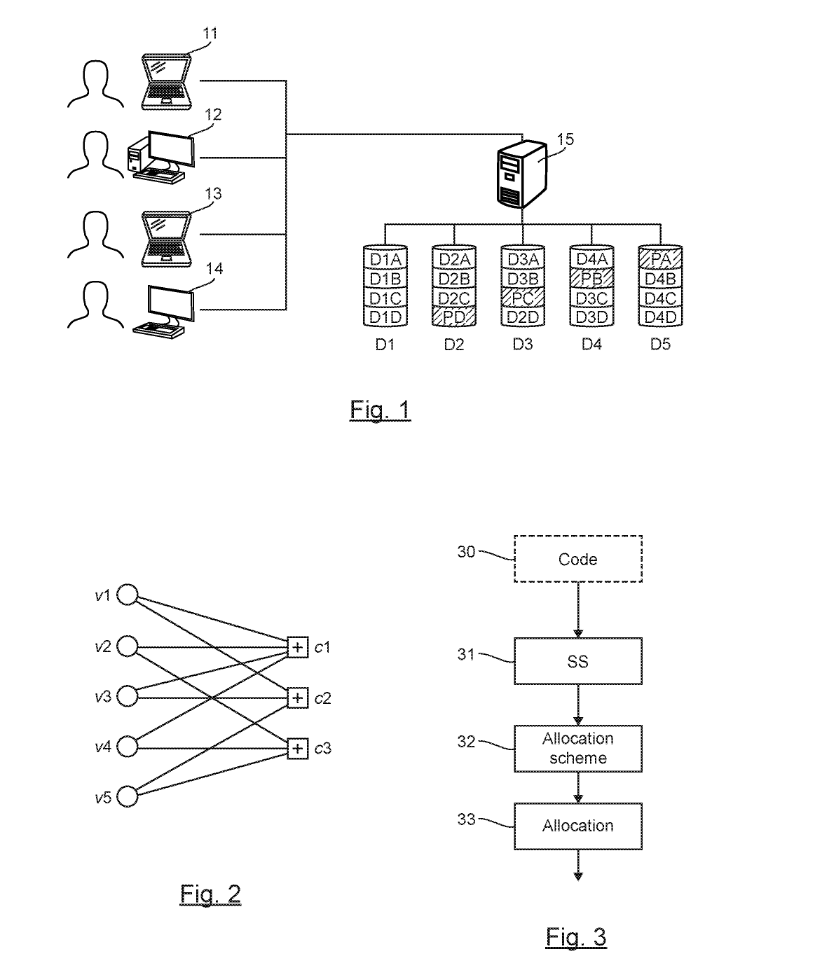

As an example, FIG. 2 illustrates an error-correction code in its representation in graph form where the circles to the left of the graph correspond to the variables v1 to v5 (which can be of the source data or redundancy data type) and the squares to the right correspond to the constraints c1 to c3.

As already indicated, such a code can be represented in an equivalent way by a system of equations or by a generator matrix or a parity check matrix.

Thus, the code shown in FIG. 2 can also be expressed in the form of the following system of equations:

$$\{ \begin{matrix}v 1 + v 2 + v 3 + v 4 & = 0 \\ v 1 + v 3 + v 5 & = 0 \\ v 2 + v 4 + v 5 & = 0\end{matrix}$$

or the following parity check matrix:

$$H = [ \begin{matrix}1 & 1 & 1 & 1 & 0 \\ 1 & 0 & 1 & 0 & 1 \\ 0 & 1 & 0 & 1 & 1\end{matrix} ]$$

where the columns of the parity check matrix represent the different variables v1 to v5 and the rows of the parity check matrix represent the different constraints c1 to c3 that the variables v1 to v5 must comply with.

The LDPC codes and their derived classes can reach or approach Shannon's limit while at the same time complying with low encoding and decoding complexity through the use of an iterative decoder, for example of the belief propagation decoder type.

This reduction of complexity has a major drawback: graph codes are not MDS codes with an iterative decoder. This means that in the case of data storage, Y redundancy disk drives are needed to support X failed hard disk drives in the network, with Y>X.

The invention presents a novel algorithm combining the use of a structured error-correction code/data allocation in order to obtain MDS operation of the graph codes in a data storage system while at the same time retaining an iterative decoder.

### 5.3 Data Storage

Here below, referring to FIG. 3, we present the main steps implemented by a method for storing data according to the invention.

Such a method can implement an error-correction code defining a set of variables linked by constraints and capable therefore of being represented by a graph. In particular, such a graph code is of a sparse type.

Such a method can, if necessary, implement a preliminary step 30 for building the code, for example when the storage algorithm is initialized.

At a first step 31, the variables forming at least one stopping set of the code, denoted as SS, are determined.

At a second step 32, a scheme for the allocation of the variables is determined, allocating a distinct storage carrier to each variable forming a stopping set.

At a third step 33, the variables (or data associated with these variables) are distributed on the storage carriers according to the allocation scheme. Each variable forming a stopping set (or each associated data) is therefore distributed to a distinct storage carrier. In particular, a step for encoding source data can be implemented prior to the distribution step. Such an encoding step enables the building, from at least one source data vector, of at least one vector of encoded data to be stored. The encoded data, associated with the variables, can therefore be stored in following the allocation scheme.

As already indicated, the graph codes are non-MDS codes when an iterative decoder is used. The main reason is the presence of stopping sets within these graph codes, which correspond to short cycles. The problem of short cycles can be presented by a system of equations in the context of data storage where the only errors considered possible are the erasure of a part of the data. When all the elements of a cycle are erased, we obtain a system of several equations possessing more than two unknowns, which makes the end of the decoding impossible.

It is thus sought according to the invention to distribute the different variables forming a short cycle and more specifically a stopping set on different storage carriers.

The invention therefore proposes to use a highly structured code where the cycles are easily identifiable (generally this type of code possesses a large number of cycles and is not considered to be high-performance code) and to ingeniously allocate the variables so that all the variables of a stopping set cannot be erased at the same time.

It may be recalled that the notion of a variable is designed at the level of the very construction of the code. An error-correction code thus defines a set of combinations that the variables must comply with. These variables can take different values corresponding to source data and redundancy data of a code word, also called a vector to be stored.

In particular, if we consider a data storage network comprising N hard disk drives, such that all the user data can be distributed amongst K disk drives, the building step 30 for building the code builds a structured code having parameters n=αN, k=αK, with α as an integer and s(H)>2(N−K), where s(H) is the stopping distance of the parity check matrix H, i.e. the smallest size of the stopping set. A stopping set sized s(H) is called a minimum stopping set.

The condition s(H)>2(N−K) ensures the distribution of the data associated with variables forming a stopping set on more than N−K disk drives. The use of a structured code facilitates the implementing of the step for determining variables forming a stopping set.

Here below we describe an example of implementation of the invention for the storage of data on a set of ten hard disk drives supporting the failures of two hard disk drives.

As indicated here above, the code chosen must make it possible to rapidly determine the cycles. To this end, a quasi-cyclic type of structure is used. It may be recalled that this structure makes it possible to extend one and the same matrix structure to infinity. Thus, if the cycles can be determined on a small given structure (of the order of about 100 variables), then the same cycles will be found regularly by extending this structure. It will then be possible to determine the stopping sets that prevent the iterative code from succeeding.

For example, the invention uses an LDGM code capable of very fast encoding of data. To this end, during the step for building the error-correction code, a parity check matrix is built comprising ten rows and 50 columns. This means that it is possible to store five bytes per sector of a hard disk drive.

Such a parity check matrix H is formed by an identical matrix sized 10×10, denoted as Id10×10, and a repetition of four patterns, column by column (11, 101, 1001, 10001):

$$H = [ \begin{matrix}{Id}_{10 \times 10} & P\end{matrix} ]$$

$$with$$

$$P = [ \begin{matrix}1 & 0 & 0 & 0 & 0 & 0 & 0 & 0 & 0 & 1 & 1 & 0 & 0 & 0 & 0 & 0 & 0 & 0 & 1 & 0 & 1 & 0 & 0 & 0 & 0 & 0 & 0 & 1 & 0 & 0 & 1 & 0 & 0 & 0 & 0 & 0 & 1 & 0 & 0 & 0 \\ 1 & 1 & 0 & 0 & 0 & 0 & 0 & 0 & 0 & 0 & 1 & 0 & 0 & 0 & 0 & 0 & 0 & 0 & 0 & 1 & 0 & 1 & 0 & 0 & 0 & 0 & 0 & 0 & 1 & 0 & 0 & 1 & 0 & 0 & 0 & 0 & 0 & 1 & 0 & 0 \\ 0 & 1 & 1 & 0 & 0 & 0 & 0 & 0 & 0 & 0 & 1 & 0 & 1 & 0 & 0 & 0 & 0 & 0 & 0 & 0 & 0 & 0 & 1 & 0 & 0 & 0 & 0 & 0 & 0 & 1 & 0 & 0 & 1 & 0 & 0 & 0 & 0 & 0 & 1 & 0 \\ 0 & 0 & 1 & 1 & 0 & 0 & 0 & 0 & 0 & 0 & 0 & 1 & 0 & 1 & 0 & 0 & 0 & 0 & 0 & 0 & 1 & 0 & 0 & 1 & 0 & 0 & 0 & 0 & 0 & 0 & 0 & 0 & 0 & 1 & 0 & 0 & 0 & 0 & 0 & 1 \\ 0 & 0 & 0 & 1 & 1 & 0 & 0 & 0 & 0 & 0 & 0 & 0 & 1 & 0 & 1 & 0 & 0 & 0 & 0 & 0 & 0 & 1 & 0 & 0 & 1 & 0 & 0 & 0 & 0 & 0 & 1 & 0 & 0 & 0 & 1 & 0 & 0 & 0 & 0 & 0 \\ 0 & 0 & 0 & 0 & 1 & 1 & 0 & 0 & 0 & 0 & 0 & 0 & 0 & 1 & 0 & 1 & 0 & 0 & 0 & 0 & 0 & 0 & 1 & 0 & 0 & 1 & 0 & 0 & 0 & 0 & 0 & 1 & 0 & 0 & 0 & 1 & 0 & 0 & 0 & 0 \\ 0 & 0 & 0 & 0 & 0 & 1 & 1 & 0 & 0 & 0 & 0 & 0 & 0 & 0 & 1 & 0 & 1 & 0 & 0 & 0 & 0 & 0 & 0 & 1 & 0 & 0 & 1 & 0 & 0 & 0 & 0 & 0 & 1 & 0 & 0 & 0 & 1 & 0 & 0 & 0 \\ 0 & 0 & 0 & 0 & 0 & 0 & 1 & 1 & 0 & 0 & 0 & 0 & 0 & 0 & 0 & 1 & 0 & 1 & 0 & 0 & 0 & 0 & 0 & 0 & 1 & 0 & 0 & 1 & 0 & 0 & 0 & 0 & 0 & 1 & 0 & 0 & 0 & 1 & 0 & 0 \\ 0 & 0 & 0 & 0 & 0 & 0 & 0 & 1 & 1 & 0 & 0 & 0 & 0 & 0 & 0 & 0 & 1 & 0 & 1 & 0 & 0 & 0 & 0 & 0 & 0 & 1 & 0 & 0 & 1 & 0 & 0 & 0 & 0 & 0 & 1 & 0 & 0 & 0 & 1 & 0 \\ 0 & 0 & 0 & 0 & 0 & 0 & 0 & 0 & 1 & 1 & 0 & 0 & 0 & 0 & 0 & 0 & 0 & 1 & 0 & 1 & 0 & 0 & 0 & 0 & 0 & 0 & 1 & 0 & 0 & 1 & 0 & 0 & 0 & 0 & 0 & 1 & 0 & 0 & 0 & 1\end{matrix} ]$$

The columns of the parity check matrix H represent the different variables v0 to v49 of the error-correction code and the rows of the parity check matrix represent the different constraints c0 to c9 that must be complied with by the variables v0 to v49.

For example, the following equations can be defined:

$$\{ \begin{matrix}v 0 = v 10 + v 19 + v 20 + v 28 + v 30 + v 37 + v 40 + v 46 \\ v 1 = v 10 + v 11 + v 21 + v 29 + v 31 + v 38 + v 41 + v 47 \\ v 2 = v 11 + v 12 + v 20 + v 22 + v 32 + v 39 + v 42 + v 48 \\ v 3 = v 12 + v 13 + v 21 + v 23 + v 30 + v 33 + v 43 + v 49 \\ v 4 = v 13 + v 14 + v 22 + v 24 + v 31 + v 34 + v 40 + v 44 \\ v 5 = v 14 + v 15 + v 23 + v 25 + v 32 + v 35 + v 41 + v 45 \\ v 6 = v 15 + v 16 + v 24 + v 26 + v 33 + v 36 + v 42 + v 46 \\ v 7 = v 16 + v 17 + v 25 + v 27 + v 34 + v 37 + v 43 + v 47 \\ v 8 = v 17 + v 18 + v 26 + v 28 + v 35 + v 38 + v 44 + v 48 \\ v 9 = v 18 + v 19 + v 27 + v 29 + v 36 + v 39 + v 45 + v 49\end{matrix}$$

where the“+” operator is an “exclusive-or” operator also called an XOR operator.

The corresponding generator matrix G comprises 50 rows and 40 columns:

$$G = [ \begin{matrix}{Id}_{40 \times 40} \\ P\end{matrix} ]$$

with P being the parity of the generator matrix used to compute the redundancy data.

Thus, if we consider a vector of data U comprising source data such that U=(u0, u1, u2, . . . , u39), then the vector of data to be stored R comprising source data and redundancy data such that R=(r0, r1, r2, . . . , r49), is obtained as follows:

R=G×U

where r0 to r39 correspond to source data and r40 to r49 correspond to redundancy data.

It can be noted in this example that the parity check matrix H and the generator matrix G both comprise the matrix P. This is a property of the LDGM codes which use a same matrix for the encoding and the decoding of the data.

Once the error-correction code has been thus built, the stopping sets of this code can be identified, for example by using the algorithm described in the documents Gerd Richter, “Finding small stopping sets in the Tanner graphs of LDPC codes”, M. Hirotomo and al, “A probabilistic algorithm for finding the minimum-size stopping sets of LDPC codes” or Orlitsky and al., “Stopping set distribution of LDPC code ensembles”.

In particular, since the parity check matrix H is highly structured, it is possible to easily determine the short cycles and especially the stopping sets.

Thus, the set of variables forming a stopping set sized 6, the set of variables forming a stopping set sized 8, etc. are identified. Then, each variable of a stopping set is distributed amongst distinct hard disk drives.

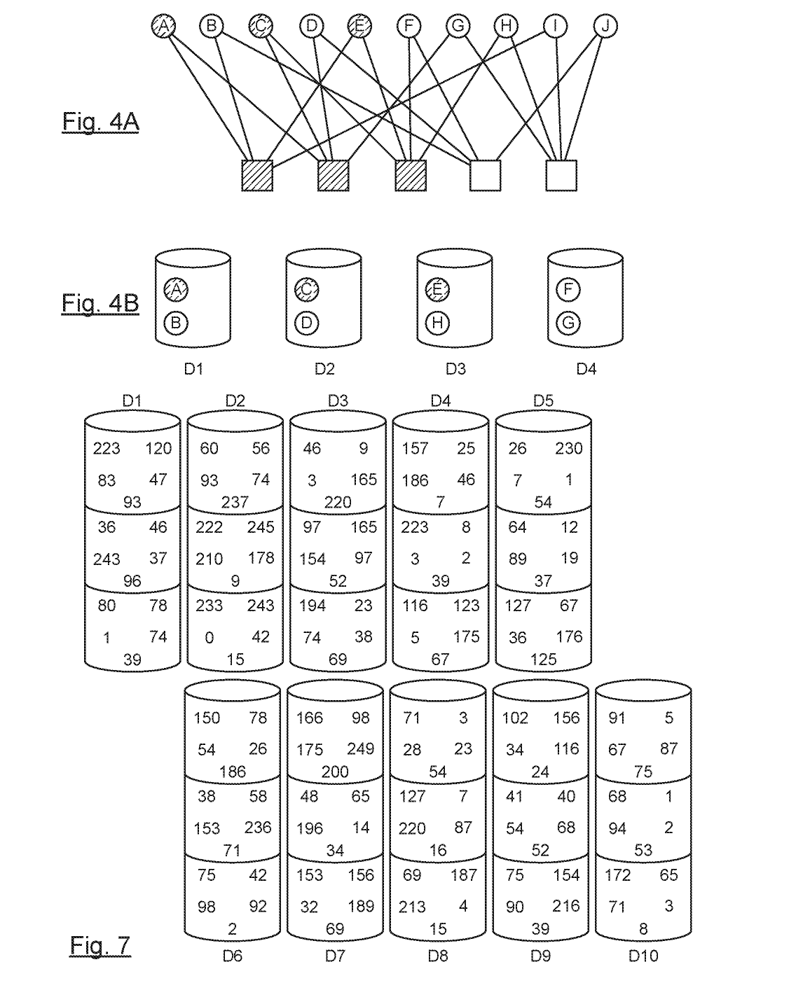

FIGS. 4A and 4B provide a simple illustration of the idea of distributing the variables forming a stopping set amongst a number of disk drives great enough to make it impossible to eliminate all the variables of a stopping set simultaneously.

In this example, the hatched nodes represent a stopping set. The size of this cycle defined by the number of nodes forming the cycle (i.e. the number of nodes of variables and constraint nodes) is equal to 6. If the variables A, C, E forming this stopping set are erased simultaneously, the decoder will have to resolve the system comprising three equations with two unknowns without any possibility of determining these unknowns. If it is considered that protection is being sought against the loss of two disk drives, then the three variables A, C, E forming this stopping set will be distributed amongst three different disk drives D1, D2, D3 to make this case of erasure impossible.

Returning to the above example in which the parity check matrix H is defined by H=[Id_{10×10}P], and taking the columns of the parity check matrix to represent the different variables v0 to v49 and the rows of the parity check matrix to represent the different constraints c0 to c9 that the variables must meet, we identify stopping sets sized 6 comprising the following: the variables v10, v11 and v20, the variables v10, v21 and v30, the variables v11, v12 and v21, the variables v11, v22, v31, the variables v12, v13, v22, the variables v12, v23, v32, etc.

More specifically, it is observed that the parity check matrix H does not have cycles sized 4. It is also noted that the two variables associated with the same pattern in the parity check matrix H (‘1’ for the first-degree variables v0 to v9, ‘11’ for the second-degree variables v10 to v19, ‘101’ for the second-degree variables v20 to v29, ‘1001’ for the second-degree variables v30 to v39 and ‘10001’ for the second-degree variables v40 to v49) generally form part of a cycle sized 6 (formed by three variables). It is therefore decided not to store two variables associated with the same pattern on the same carrier. In addition, it is observed that if all the variables allocated to a same storage carrier do not come into play more than once on all the rows, then, by complying with the point stated above, it will not be possible to fall into a cycle sized 6 during the erasure of two storage carriers.

The allocation scheme can then be built iteratively by complying with the following rules.

For example, for the first disk drive D1:
a) the first first-degree variable, namely the variable v0, is taken;
b) the first second-degree variable according to the pattern ‘11’, with a zero in the same equation as the variable chosen here above, namely the variable v11, is taken;
c) the first second-degree variable according to the pattern ‘101’ with non-zeros on the “free” equations, namely the variable v23, is taken;
d) the first second-degree variable according to the pattern ‘1001’ with the non-zeros on the “free” equations, namely the variable v34, is taken;
e) a problem is seen for the selection of the first second-degree variable according to the pattern ‘10001’, because it does not comply with the rules defined here above. The selection made on d, namely the variable v34 is therefore eliminated;
f) the first second-degree variable according to the pattern ‘10001’ with the non-zeros on the “free” equations, namely the variable v44, is taken;
g) the first second-degree variable according to the pattern ‘1001’ with the non-zeros on the “free” equations, namely the variable v36, is taken.

This method is continued in this way for the different variables, and then the same principle is used on the other disk drives.

A known algorithm, such as for example the one proposed in the above-mentioned document by Gerd Richter, “Finding small stopping sets in the Tanner graphs of LDPC codes”, can also be used to determine the short cycles.

Once the stopping sets have been identified, the variables of each stopping set are distributed on distinct disk drives.

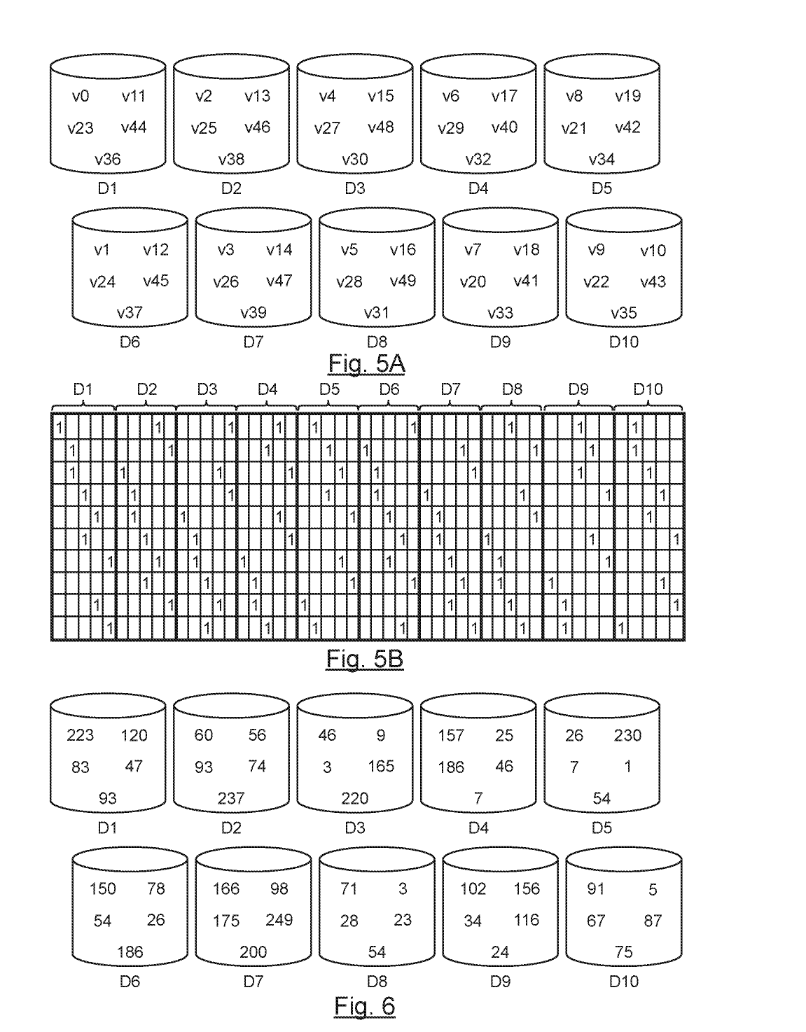

FIGS. 5A and 5B present two equivalent allocation schemes illustrating an example of distribution of these variables amongst ten disk drives D1 to D10 in working with five bytes per disk drive according to the invention. More specifically, the FIG. 5A presents the result of the distribution of the variables amongst all ten disk drives and FIG. 5B illustrates an allocation matrix enabling this result to be obtained. For example, the variables v0, v11, v23, v44 and v36 (or the values carried by these variables) are allocated to the disk drive D1, the variables v2, v13, v25, v46 and v38 (or the values carried by these variables) are allocated to the disk drive D2, the variables v4, v15, v27, v48 and v30 (or the values carried by these variables) are allocated to the disk drive D3, the variables v6, v17, v29, v40 and v32 (or the values carried by these variables) are allocated to the disk drive D4, the variables v8, v19, v21, v42 and v34 (or the values carried by these variables) are allocated to the disk drive D5, the variables v1, v12, v24, v45 and v37 (or the values carried by these variables) are allocated to the disk drive D6, the variables v3, v14, v26, v47 and v39 (or the values carried by these variables) are allocated to the disk drive D7, the variables v5, v16, v28, v49 and v31 (or the values carried by these variables) are allocated to the disk drive D8, the variables v7, v18, v20, v41 and v33 (or the values carried by these variables) are allocated to the disk drive D9, the variables v9, v10, v22, v43 and v35 (or the values carried by these variables) are allocated to the disk drive D10. It will be noted that the order of allocation on the disk drives is of no importance. In other words, the variables v0, v11, v23, v44 and v36 could equally well be allocated to the disk drive D2 rather than to the disk drive D1.

In other words, the allocation proposed according to the invention is used to distribute the variables in such a way that each disk drives stores a set of variables that come into play only in nine different equations. This means that the set of variables of a same disk drive do not come into play on a row of the parity check matrix.

As already indicated, the parity check matrix, which is highly structured, possesses numerous closed short cycles. The allocation therefore makes it possible to distribute the variables in such a way that the variables that come into play in the stopping sets are stored on more than two disk drives. For example, the variables v26, v42 and v48, and the variables v14, v22, v32 form two cycles which could block the iterative decoding in the event of failure of a disk drive storing these variables. According to the invention, therefore, these variables are distributed amongst three different disk drives (D7, D5 and D3 for the first stopping set, and D7, D10 and D4 for the second stopping set). Since the system is built to support two losses, the simultaneous erasure of the three variables forming these stopping sets is considered to be impossible.

This allocation therefore ensures the rebuilding of the data for each of the erasures sized 2 (and of course sized 1).

Here below, we present an example of data storage applying the method for storing data according to at least one embodiment of the invention.

As indicated here above, the generator matrix G can be obtained from the parity control matrix H. This generator matrix G makes it possible to obtain a vector of data to be stored R from a source data vector U.

For example, the code built according to the invention is systematic. The values of the source data vector U are therefore found identically in the vector of data to be stored R, which therefore includes source data and redundancy data.

We consider for example a source data vector U1 bearing the following symbols:

U1=[5,120,78,56,98,9,3,25,156,230,34,7,67,83,54,93,175,3,28,186,220,54,7,24,54,75,93,186,237,200,46,116,1,87,47,26,74,249,165,23]

By applying the generator matrix G to this source data vector U1, i.e. in applying the error-correction code to the source data vector U1, we obtain a vector of data to be stored R1 bearing the following symbols:

R1=[5,120,78,56,98,9,3,25,156,230,34,7,67,83,54,93,175,3,28,186,220,54,7,24,54,75,93,186,237,200,46,116,1,87,47,26,74,249,165,23,223,150,60,166,46,71,157,102,26,91]

These values can be applied to the variables v0 to v49 defined here above, for example as proposed here below:

v0 = 223
v1 = 150
v2 = 60
v3 = 166
v4 = 46
v5 = 71
v6 = 157
v7 = 102
v8 = 26
v9 = 91
v10 = 5
v11 = 120
v12 = 78
v13 = 56
v14 = 98
v15 = 9
v16 = 3
v17 = 25
v18 = 156
v19 = 230
v20 = 34
v21 = 7
v22 = 67
v23 = 83
v24 = 54
v25 = 93
v26 = 175
v27 = 3
v28 = 28
v29 = 186
v30 = 220
v31 = 54
v32 = 7
v33 = 24
v34 = 54
v35 = 75
v36 = 93
v37 = 186
v38 = 237
v39 = 200
v40 = 46
v41 = 116
v42 = 1
v43 = 87
v44 = 47
v45 = 26
v46 = 74
v47 = 249
v48 = 165
v49 = 23

The symbols of the vector of data to be stored R1 can therefore be stored on the ten hard disk drives in complying with the allocation scheme proposed for the variables v1 to v49.

FIG. 6 illustrates the result of the storage operation.

The preceding operations can be reiterated for the following source data vectors. For example, by applying the generator matrix G to a source data vector U2, i.e. by applying the error-correction code to the source vector data U2 such that:

U2=[1,46,58,245,65,165,7,8,40,12,54,89,94,243,153,210,196,154,220,3,52,16,39,52,37,53,96,71,9,34,2,68,198,2,37,236,178,14,97,87]

a vector of data to be stored R2 carrying the following symbols is obtained:

R2=[1,46,58,245,65,165,7,8,40,12,54,89,94,243,153,210,196,154,220,3,52,16,39,52,37,53,96,71,9,34,2,68,198,2,37,236,178,14,97,87,36,38,22,48,97,127,223,41,64,68]

By applying the generator matrix G to a source data vector U3, such that:

U3=[65,78,42,243,156,23,187,123,154,67,90,36,71,1,98,0,32,74,213,5,69,15,67,39,125,8,39,2,15,69,176,216,176,3,74,92,42,189,38,4]

a vector of data to be stored R3 carrying the following symbols is obtained:

R3=[65,78,42,243,156,23,187,123,154,67,90,36,71,1,98,0,32,74,213,5,69,15,67,39,125,8,39,2,15,69,176,216,176,3,74,92,42,189,38,4,80,75,233,153,194,69,116,75,127,172]

These values can be applied to the variables v0 to v49 defined here above.

For example, the variables v0 to v49 defined here above can successively take the following values (where, for each cell, the three numbers correspond respectively to a symbol of the vector to be stored R1, a symbol of the vector to be stored R2, and a symbol of the vector to be stored R3):

v0 = 223; 36; 80
v1 = 150; 38; 75;
v2 = 60; 222; 233
v3 = 166; 48; 153
v4 = 46; 97; 194
v5 = 71; 127; 69
v6 = 157; 223; 116
v7 = 102; 41; 75
v8 = 26; 64; 127
v9 = 91; 68; 172
v10 = 5; 1; 65
v11 = 120; 46; 78
v12 = 78; 58; 42
v13 = 56; 245; 243
v14 = 98; 65; 156
v15 = 9; 165; 23
v16 = 3; 7; 187
v17 = 25; 8; 123
v18 = 156; 40; 154
v19 = 230; 12; 67
v20 = 34; 54; 90
v21 = 7; 89; 36
v22 = 67; 94; 71
v23 = 83; 243; 1
v24 = 54; 153; 98
v25 = 93; 210; 0
v26 = 175; 196; 32
v27 = 3; 154; 74
v28 = 28; 220; 213
v29 = 186; 3; 5
v30 = 220; 52; 69
v31 = 54; 16; 15
v32 = 7; 39; 67
v33 = 24; 52; 39
v34 = 54; 37; 125
v35 = 75; 53; 8
v36 = 93; 96; 39
v37 = 186; 71; 2
v38 = 237; 9; 15
v39 = 200; 34; 69
v40 = 46; 2; 175
v41 = 116; 68; 216
v42 = 1; 19; 176
v43 = 87; 2; 3
v44 = 47; 37; 74
v45 = 26; 236; 92
v46 = 74; 178; 42
v47 = 249; 14; 189
v48 = 165; 97; 38
v49 = 23; 87; 4

According to a first variant, illustrated in FIG. 7, the step of distribution stores the source data or the redundancy data allotted to a given variable on a same storage carrier. Thus, the values 223, 36 and 80 allotted to the variable v0 are stored on the disk drive D1.

According to a second variant illustrated in FIG. 8, the step of distribution stores the source data or the redundancy data allotted to a given variable on distinct storage carriers.

Thus, the values 223, 36 and 80 allotted to the variable v0 are respectively stored on the disk drive D1, the disk drive D2 and the disk drive D3.

It is assumed that, for this purpose, the disk drives can be sub-divided into stripes, each stripe being associated with a vector to be stored. The first vector to be stored R1 is stored as described here above. The second vector to be stored R2 is stored as described here above with a shift by one disk drive from the first vector to be stored R1. The third vector to be stored R3 is stored as described here above with a shift by one disk drive from the second vector to be stored R2.

The step for distributing variables is therefore implemented “stripe by stripe”, in determining a first allocation scheme for the first stripe, then a second allocation scheme for the second stripe, a third allocation scheme for the third stripe, etc. According to the example illustrated in FIG. 8, the same allocation scheme is used with a shift by one hard disk drive.

In this way, the redundancy (parity) data are distributed amongst the different disk drives as proposed in level 5 of the RAID algorithm (“parity striping”).

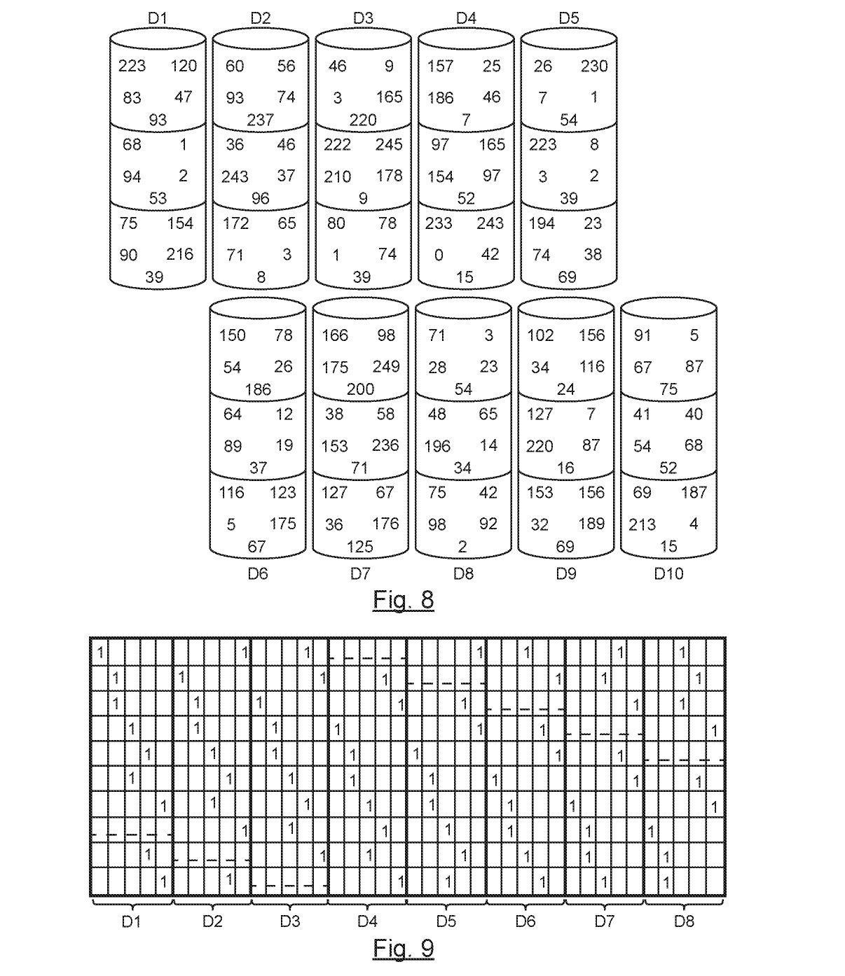

Purely by way of an illustration, FIG. 9 presents another example of distribution of the variables on eight disk drives D1 to D8, supporting the failure of two hard disk drives.

This scheme or allocation matrix corresponds to a lower triangular LDPC matrix and is obtained by eliminating certain columns of the allocation matrix illustrated in FIG. 5B.

According to this example, the average complexities of encoding and decoding amount to 6.2 XOR operations per byte.

### 5.4 Decoding of the Data

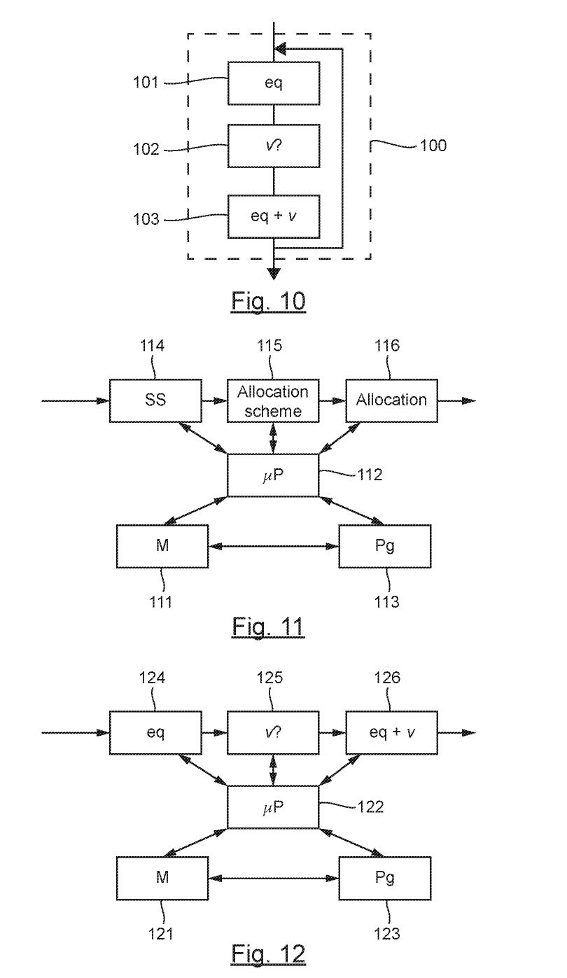

Here below, referring to FIG. 10, we present the main steps implemented by a method for decoding data according to the invention, enabling the decoding of data stored according to an embodiment of the method for storing data described here above.

According to the invention, such a method of decoding enables the source data to be recovered even in the event of erasure of one or more storage carriers.

To this end, a decoding method of this kind implements a step 100 for decoding, comprising at least one iteration of the following steps, when at least one of the storage carriers has failed:
searching 101 in a system of equations representing the code, for at least one equation having a single variable associated with data (source and/or redundancy) preliminarily stored on the failed storage carrier or carriers, called an erased variable. This step makes it possible especially to identify the equations with a single unknown of the system of equations, that can be easily resolved.
rebuilding 102 the data associated with the erased variable or variables by resolution of the equation or equations delivering at least one rebuilt data.
updating 103 the system of equations taking account of the at least one rebuilt data. This step makes it possible especially to update the equations in which the variable or variables associated with the rebuilt data at the step 102 come into play.

These steps of searching 101, rebuilding 102 and updating 103 the system of equations are implemented so long as all the variables are not determined. In particular, the step of updating can be implemented whenever a data is rebuilt.

A decoding step 100 is implemented for the decoding of each stored vector R, i.e. stripe by stripe.

More specifically, an example is presented of an implementation of the invention for the decoding of data stored on a set of ten hard disk drives as illustrated in FIG. 7, supporting the failures of two hard disk drives.

It is assumed that the disk drives D1 and D2 have failed. Hence only the disk drives D3 to D10 are available to rebuild the source data (user data).

The decoding step described here above is applied to the first stripe.

A search is made first of all in the system of equations representing the code, during a first iteration, for an equation or several equations having a single variable associated with a data preliminarily stored on the failed storage carrier or carriers, called an erased variable. This step makes it possible especially to identify the equations with a single unknown of the system of equations, which can be easily resolved.

The first equation, which corresponds to the first row of the parity check matrix, i.e. v0+v10+v19+v20+v28+v30+v37+v40+v46=0, comprises two unknowns since the data associated with the variables v0 and v46 which were stored on the disk drives D1 and D2, have been erased.

The second equation which corresponds to the second row of the parity check matrix, i.e. v1+v10+v11+v21+v29+v31+v38+v41+v47=0, comprises two unknowns since the data associated with the variables v11 and v38, which were stored on the disk drives D1 and D2, have been erased.

This is equally the case for:

the third equation: v2+v11+v12+v20+v22+v32+v39+v42+v48=0

the fourth equation: v3+v12+v13+v21+v23+v30+v33+v43+v49=0

the fifth equation: v4+v13+v14+v22+v24+v31+v34+v40+v44=0

the sixth equation: v5+v14+v15+v23+v25+v32+v35+v41+v45=0

the seventh equation: v6+v15+v16+v24+v26+v33+v36+v42+v46=0.

However, the eighth equation v7+v16+v17+v25+v27+v34+v37+v43+v47=0 comprises only one unknown, the data associated with the variable v25.

Its value can therefore be determined by resolving the eighth equation:

v25=v7+v16+v17+v27+v34+v37+v43+v47

v25=102+3+25+3+54+186+87+249

v25=93

The ninth equation, i.e. v8+v17+v18+v26+v28+v35+v38+v44+v48=0, comprises two unknowns.

By contrast, the tenth equation v9+v18+v19+v27+v29+v36+v39+v45+v49=0 comprises only one unknown, the data associated with the variable v36.

It is therefore possible to determine its value by resolving the tenth equation:

v36=v9+v18+v19+v27+v29+v39+v45+v49

v36=91+156+230+3+186+200+26+23

v36=93

The system of equations can then be updated in taking account of the rebuilt values of the variables v25 and v36. This step makes it possible especially to update the equations in which the variables v25 and v36 come into play.

A search is then made, in the system of equations representing the code, during a second iteration, for one or more equations having a single erased variable.

The first equation still comprises two unknowns. This is also the case for the second, third, fourth, fifth and ninth equations.

By contrast, the sixth equation comprises a single unknown, the data associated with the variable v23.

We can therefore determine its value by resolving the sixth equation:

v23=v5+v14+v15+v25+v32+v35+v41+v45

v23=71+98+9+93+7+75+116+26

v23=83

In the same way, the seventh equation comprises only one unknown, the data associated with the variable v46. By resolving the seventh equation, we obtain v46=74.

The system of equations can then be updated in taking account of the rebuilt values of the variables v23 and v46.

By a similar procedure, it is possible to determine the values of the variables v0 (v0=223), v13 (v13=56), v44 (v44=47) and v38 (v38=237) during a third iteration, and then the values of the variables v11 (v11=120) and v2 (v2=60) during a fourth iteration.

The system of equations is then resolved, signifying that the first stripe, corresponding to the first stored vector, can be decoded and the source data rendered even after erasure of the two hard disk drives.

As indicated here above, the decoding step 100 can be implemented stripe by stripe.

If the distribution step, implemented during the storage of data, is considered to store source data or redundancy data allocated to a given variable on the same storage carrier, according to the first variable illustrated in FIG. 7, then the decoding method can memorize the order of resolution of the equations of the system of equations implemented during the step for decoding the first stripe.

In this way, during the step for decoding the second stripe and the third stripe, the decoding method knows the optimal order of resolution of the equations, giving a considerable gain in time to the decoding process.

More specifically, in the example illustrated in FIG. 7, the allocation is done so that the values of the second vector to be stored R2 are positioned on the same disk drive as the values of the first vector to be stored R1 corresponding to the same position in the equation. We therefore again have the same unknowns in the parity check matrix H and therefore the same system of equations to be resolved.

Since the order in which the system of equations has been resolved for the first stripe is known, this same order of resolving equations is applied to resolve the system of equations of the second stripe.

Thus, we start by resolving the eighth equation (v25=210), then the tenth equation (v36=96), then the sixth equation (v23=243), then the seventh equation (v46=178), then the first equation (v0=36), then the fourth equation (v13=245), then the fifth equation (v44=37), then the ninth equation (v38=9), then the second equation (v11=46), and finally the third equation (v2=222). Whenever an equation is resolved, the system of equations is updated with the rebuilt data, thus making it possible to have a single unknown for each equation.

In the same way, the same order of resolving equations is applied to resolve the system of equations of the third stripe.

It is thus possible to remove the need for the step of searching for the equations with one unknown quantity of the system of equations, this step considerably increasing the complexity of the decoding.

The decoding time is thus optimized. It can be noted that this gain in time will be all the greater as the size of the generator matrix or the parity check is great.

### 5.4 Alternative Embodiments

Here above, an example of implementation has been described for the storage of data and the decoding of data stored using an error-correction code of the LDGM type.

Naturally, the invention is not limited to this type of error-correction code and any sparse type graph code (i.e. codes whose generator matrix and/or parity check matrix are sparse) can be used.

For example, it is possible to use a staircase quasi-cyclic LDPC non-binary type of error-correction code, the base building of which is described especially in the following documents: C. Yoon et a, “A hardware efficient LDPC encoding scheme for exploiting decoder structure and resources” (VTC Spring '07, 2007, pp. 2445-2449) and “Arbitrary bit generation and correction technique for encoding GC-LDPC codes with dual-diagonal parity structure” (WCNC '07, 2007, pp. 662-666).

According to this example, it is possible to build the code to store the data on 12 hard disk drives and protect them from three erasures. The step for building the code proposes to comply with the staircase structure which enables a low-cost encoding through the transformation algorithm of the parity check matrix H proposed in the document by T. J. Richardson and R. L. Urbanke, “Efficient encoding of Low-Density Parity-Check Codes” (IEEE Transactions on Information Theory, Vol. 47, N^{o} 2, February 2001), and to build a relatively small-sized base matrix without cycle sized 6. Then, the quasi-cyclic nature makes it easy to extend the size of the matrix. If we consider a sector size of 512 bytes per disk drive and a stripe size of one sector, the size of the code obtained is: N=number of disk drives×size of one stripe=12×512=6144. The number of equations of the system of equations to be resolved is therefore M=3×512=1536. The simulation results show a remarkable gain in decoding time especially. Thus, we observe an average of 0.170 ms per stripe for the encoding/storing of the data and 780 ms for the decoding of the first stripe and then an average of 0.060 ms for the following stripes. In addition, all the cases of erasures of three disk drives have been corrected without error.

### 5.5 Simplified Structures of a Storage Device and of a Decoding Device

Finally, referring to FIGS. 11 and 12 respectively, we present the simplified structure of a data storage device and the simplified structure of a device for decoding data stored according to one embodiment of the invention.

As illustrated in FIG. 11, a device for storing data according to at least one embodiment of the invention comprises a memory 111 comprising a buffer memory, a processing unit 112, equipped for example with a microprocessor μP, and driven by the computer program 113 implementing the method for storing data according to at least one embodiment of the invention.

At initialization, the code instructions of the computer program 113 are for example loaded into a RAM and then executed by the processor of the processing unit 112. The processing unit 112 inputs at least one source data vector. The microprocessor of the processing unit 112 implements the steps of the method for storing data according to at least one embodiment described here above according to the instructions of the computer program 113, to encode the vector or vectors of source data and distribute the symbols of the vector or vectors to be stored thus obtained amongst the different storage carriers. To this end, the data storage device comprises, in addition, to the buffer memory 111, a module 114 for determining variables forming at least one stopping set of the code, a module 115 for determining an allocation scheme for allocating said variables, allocating a distinct storage carrier to each variable forming a stopping set, and a module 116 for distributing the variables or data associated with the variables amongst the storage carriers according to the allocation scheme.

These modules are driven by the microprocessor of the processing unit 112.

As illustrated in FIG. 12, a device for decoding data according to at least one embodiment of the invention comprises a memory 121 comprising a buffer memory, a processing unit 122, equipped for example with a microprocessor μP, and driven by the computer program 123 implementing the method for decoding according to at least one embodiment of the invention.

At initialization, the code instructions of the computer program 123 are for example loaded into a RAM and then executed by the processor of the processing unit 122. The processing unit 122 has available a set of data stored on the storage carriers, at least one of which has failed. The microprocessor of the processing unit 122 implements the step of the method for decoding described here above according to the instructions of the computer program 123 to recover all the source data from the stored data. To this end, the storage device comprises, in addition to the buffer memory 121, a decoding module comprising a search module 124 for searching, in a system of equations representing the code, for at least one equation having a single variable associated with a data preliminarily stored on the failed storage carrier or carriers, called an erased variable, a module 125 for rebuilding the erased variable or variables, by resolving the equation or equations delivering at least one rebuilt data, a module 126 for updating the system of equations taking account of the rebuilt data, activated at least once, when at least one of the storage carriers has failed. These modules are driven by the microprocessor of the processing unit 122.

1. A method for storing data, the method implementing an error-correction code defining a set of variables linked by constraints, each variable being associated with source data and/or redundancy data, wherein the method comprises the following acts implemented by a storage device:
determining variables forming at least one stopping set of said code,
determining an allocation scheme for allocating said variables, allocating a distinct non-transitory storage carrier to each variable forming a stopping set, and
distributing said variables, or data associated with said variables, to said storage carriers according to said allocation scheme.

2. The method for storing data according to claim 1, wherein said error-correction code is a sparse graph code having a generator matrix or parity check matrix that is a sparse matrix.

3. The method for storing data according to claim 1, wherein said error-correction code is systematic.

4. The method for storing data according to claim 1, wherein the storage device implements a preliminary act of building said error-correction code which determines a generator matrix or a parity check matrix formed from a repetition of at least one predetermined pattern, called a structured matrix.

5. The method for storing data according to claim 1, wherein said act of distributing stores the data associated with a given variable on a same storage carrier.

6. The method for storing data according to claim 1, wherein said step for act of distributing stores the data associated with a same variable on distinct storage carriers.

7. The method for storing data according to claim 1, wherein said storage carriers belong the group consisting of:
hard disk drives,
magnetic tapes,
flash memories.

8. A device for storing data using an error-correction code defining a set of variables linked by constraints, each variable being associated with source data and/or redundancy data, wherein the device comprises:
a non-transitory computer-readable storage medium comprising instructions stored thereon;
a module for determining variables forming at least one stopping set of said code,
a module for determining an allocation scheme for allocating said variables, allocating a distinct storage carrier to each variable forming a stopping set,
a module for distributing said variables or data associated with said variables on the storage carriers according to said allocation scheme; and
a processor configured by the instructions to drive the modules.

9. A method for decoding data stored in a plurality of storage carriers, said data having been preliminarily stored in a plurality of storage carriers by implementing an error-correction code defining a set of variables connected by constraints, each variable being associated with source data and/or redundancy data, and by implementing:
determining variables forming at least one stopping set of said code,
determining an allocation scheme for allocating said variables, allocating a distinct non-transitory storage carrier to each variable forming a stopping set,
distributing said variables, or data associated with said variables, on said storage carriers, according to said allocation scheme,
wherein said method for decoding comprises at least one iteration of the following acts implemented by a decoding device, when at least one of the storage carriers has failed:
searching, in a system of equations representing said code, for at least one equation presenting a single variable associated with a data preliminarily stored in said at least one failed storage carrier, called an erased variable,
rebuilding said data associated with said erased variable or variables by resolving said equation or equations, delivering at least one rebuilt data, and
updating said system of equations taking account of said at least one rebuilt data.

10. The method for decoding data according to claim 9, wherein, if said distributing stores the source data or redundancy data allocated to a given variable on a same storage carrier, said method comprises the decoding device memorizes an order of resolving of said equations of said system of equations implemented during decoding of a first set of stored data,
and, during a decoding of at least one second set of stored data, said method comprises the decoding device resolving the equations of said system of equations according to said order of resolution.

11. A decoding device for decoding data stored in a plurality of non-transitory storage carriers,
said data having been preliminarily stored in said plurality of storage carriers by a device for storing data using an error-correction code, defining a set of variables connected by constraints, each variable being associated with source data and/or redundancy data, and comprising:
a module for determining variables forming at least one stopping set of said code,
a module for determining an allocation scheme for allocating said variables, allocating a distinct storage carrier to each variable forming a stopping set,
a module for distributing said variables, or data associated with said variables, on said storage carriers, according to said scheme of allocation,
wherein said decoding device comprises:
a non-transitory computer-readable storage medium comprising instructions stored thereon;
a decoding module comprising the following modules activated at least once when at least one of said storage carriers has failed:
a search module making a search, in a system of equations representing said code, for at least one equation having a single variable associated with a data preliminarily stored on said at least one failed storage carrier, called an erased variable,
a module rebuilding said data associated with the erased variable or variables, by resolution of the equation or equations, delivering at least one rebuilt data,
a module updating said system of equations taking account of said at least one rebuilt data; and
a processor configured by the instructions to drive the decoding module.

12. A non-transitory computer-readable medium comprising a program stored thereon, the program comprising instructions for execution of a method for storing data when said program is executed by a computer, the method implementing an error-correction code defining a set of variables linked by constraints, each variable being associated with source data and/or redundancy data, wherein the instructions configure the computer to perform acts of:
determining variables forming at least one stopping set of said code,
determining an allocation scheme for allocating said variables, allocating a distinct non-transitory storage carrier to each variable forming a stopping set, and
distributing said variables, or data associated with said variables, to said storage carriers according to said allocation scheme.
